(19) United States
(12) Patent Application Publication
(10) Pub. No.: US 2009/0023586 A1
(43) Pub. Date: Jan. 22, 2009

(54) Transfer printing

(76) Inventor: Darryl Zinman, Montreal (CA)

Correspondence Address: Franz BONSANG;c/o EQUINOX PROTECTION, 410 - 1500, Du College, St-Laurent, QC, H4L 5G6, CA

(21) Appl. No.: 11/826,445

(22) Filed: Jul. 16, 2007

(51) Int. Cl. B41M 5/025

(52) U.S. Cl. 503/201; 503/227

(57) ABSTRACT

Transfer printing system include a transfer substrate provided of a transfer side thereof with a preformed design area intended to be completed by the user with selected decorative materials to generate a personalized image. When the image is completed and ready for transfer, the substrate is pressed onto a surface whereby the transfer of the image is effected.

### FIELD OF THE INVENTION

The present invention relates to transfer printing in the general field of decalcomania.

More particularly, the invention has reference to transfer printing system for generating one or more images on a substrate to be transferred and set onto a surface which may be flexible or rigid. Further, the invention concerns a method of effecting the transfer of such generated image or images from the substrate to the surface intended to carry the image.

### BACKGROUND OF THE INVENTION

Decalcomania as a decorative technique is well known and was conceived in the early part of the nineteenth century. It has been developed over the years with the many advances in technology that have occurred, especially during the last century.

The techniques that are currently available are legion, but there remains a niche for an improved transfer printing system and method of application that can facilitate usage by both amateur and professional artisans.

US Patent Application Publication No.: US 2004/0067468 to Davy discloses a coloring/painting kit providing a picture material bearing a plurality of picture areas wherein each of the picture areas is outlined with a color indicative of the color to be applied and coloring media are supplied for application in this manner. One of the problems attendant upon this approach is that when infants use the kit without the dexterity of adults, errant coloring or painting occurs outside the designated picture areas and accordingly the picture material has to be customized according to the age of the user to avoid blurring or other distortion of the finished transfer print. Clearly, this requirement is disadvantageous since it is desirable to produce a kit suitable for use across the age profile. Davy tried, unsuccessfully, to solve the problem by having relatively thick or wide contour lines, which do not totally prevent anyone from applying color there beyond.

There is accordingly a need for an improved transfer printing system and method of application thereof.

### SUMMARY OF THE INVENTION

It is therefore a general object of the present invention to provide an improved transfer printing system and a method of transferring images pregenerated on a substrate to a surface.

A further object of the present invention is to provide a transfer substrate carrying a preformed outline design adapted for the creation of an image in practice to be personalized by the user.

Another object of the invention is to provide such a substrate that allows the application of a multi-coloured and/or multi-textured materials within the outline design to create the desired image when transferred to said surface.

A still further object of the present invention is the provision of a substrate that will carry decorative materials of varying physical form in the designated area ready for transfer to the said surface.

According to a first aspect of the present invention, there is provided a transfer printing system comprising a transfer substrate in sheet form provided with a transfer side, a preformed design area carried on the said transfer side of the substrate and adapted to receive decorative materials, the preformed design area being provided with a release agent, and a non-adherent zone on the transfer side of the substrate extending around the design area.

A removable protective cover is conveniently provided for the transfer substrate and may be utilized in the method of transferring the image generated by the user.

The release agent may advantageously be in the form of a coating applied to the preformed design area. The release agent may be viscous and may be transparent or translucent with a mild pigmentation, and may be produced from a waxy, adhesive, clear epoxy or resin, rubbery, plastisol, oil-, acrylic- or water-based substance.

According to a second aspect of the present invention there is provided a kit for transfer printing comprising in combination transfer printing system in accordance with the first aspect of the invention, and at least one type of decorative material for application to the preformed design area on the transfer side of the transfer substrate.

The kit may be provided with more than one substrate sheet and more than one type of decorative material.

For example, the decorative materials may be colouring media in liquid or oil form, or may be particulate materials of metal or decorative dusts, or beads or small crystals, or the substances may be fluorescent or phosphorescent, or may be of an odorous character. Further, the decorative materials may include or comprise thermally responsive materials which react to temperature change following application to the surface. Such thermally responsive materials are known in common parlance as mood rings.

The decorative materials may be applied to the preformed design area by any suitable method, process or means, selected from the following by way of example only: manually by brush, by pen, pencil, crayon, by tubed materials, as a gel, as a paint, by air spraying in wet or dry mode. It will be understood by those skilled in the art that the foregoing list of decorative materials is not exhaustive and that accordingly others are encompassed within the practice of the present invention.

In a third aspect of the present invention, there is provided a method of transferring an image using transfer printing system according to the first aspect of the invention, the method comprising the steps of removing the protective cover from the transfer substrate to reveal the transfer side and accordingly the preformed design area, applying at least one decorative material within the said design area to generate a personalized image, placing the transfer substrate onto a surface intended to carry said image, causing the image to transfer permanently to the surface by employing a suitable process in accordance with the nature of the decorative materials applied.

The process employed to effect permanent transfer of the generated image may be pressure, heat or light application or any combination thereof, whereby the materials from which the image is generated are fused, gelled, or solidified, as the case may be.

The surface to which the image is applied may be carried by a flexible or a rigid sheet or other formation. For example, a flexible sheet may be a textile in the form of a T-shirt. A rigid sheet may be of wood, glass, metal, ceramic or of rigid plastics. Indeed, the surface may of a kind used in any application of decalcomania.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a top perspective view of a transfer printing system in accordance with the present invention showing a protective cover being removed from a transfer substrate sheet;

FIG. 2 is a top perspective view similar to that of FIG. 1 showing the protective cover removed and illustrating the application of a decorative material to the preformed design area;

FIG. 3 is a top perspective view demonstrating a first step in the application of the generated image to a surface of a T-Shirt;

FIG. 4 is a top perspective view similar to that of FIG. 3 illustrating a second step in the application of said image; and

FIG. 5 is a top perspective view similar to those of FIGS. 3 and 4 illustrating a third and final step in the application of the said image.

### DETAILED DESCRIPTION OF THE PREFERRED EMBODIMENTS

With reference to the annexed drawings the preferred embodiments of the present invention will be herein described for indicative purpose and by no means as of limitation.

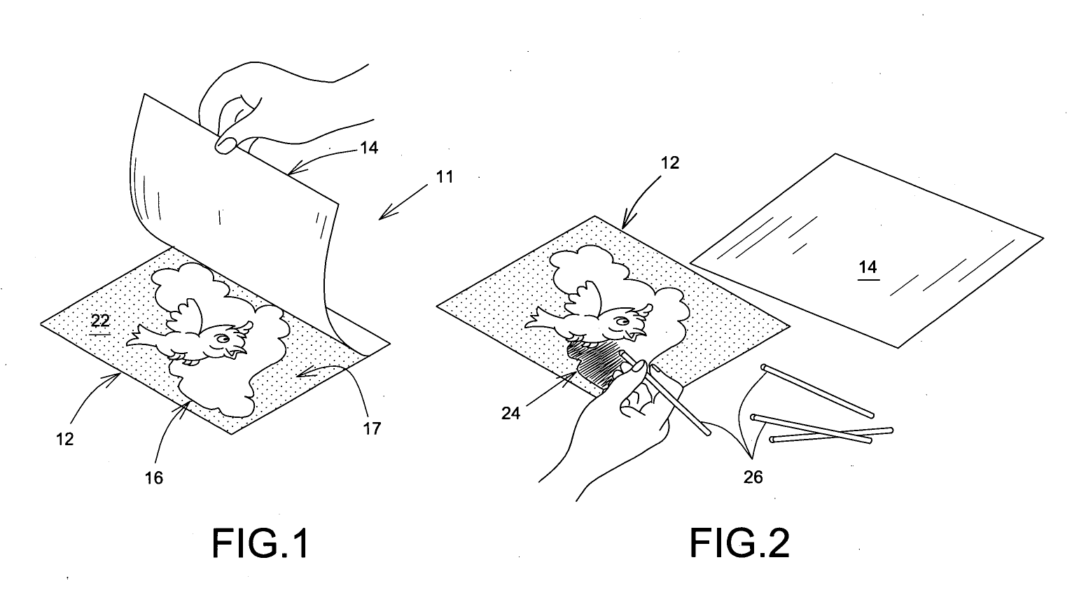

Referring to FIG. 1, there is schematically shown transfer printing system 11 comprising a transfer substrate 12 provided with a removable protective cover 14, the substrate 12 being in the form of a sheet or page on which is provided a preformed design area 16 on its transfer side 17. In this example, the area defines a cloud formation 18 with a young bird 20 in flight. The design area 16 is surrounded by unmarked zone 22 (shown in dotted shading in the drawings) which is non-adherent in respect of any of the decorative materials to be applied within the area 16.

In order to commence the preparation of the transfer printing system 11, the protective cover 14 is removed as shown in FIG. 1 to reveal the preformed design area 16.

FIG. 2 depicts the application of decorative materials to the area 16, in particular to the cloud formation 18 initially, and subsequently to the young bird 20 although this application is not shown, to generate a personalized image 24, namely one with colours or texture of individual choice. In this example, crayons 26 are used for the colouring of the design area 16. It is to be understood that the design area 16 is of sufficient indentation to accommodate the decorative materials to be applied.

Once the colouring step has been completed, the transfer printing system 11 is ready for use in the transfer of the generated image. If there should be any inadvertent contamination of the zone 22 by the decorative materials, because of its non-adherent nature those materials will merely fall away or be easily brushed off.

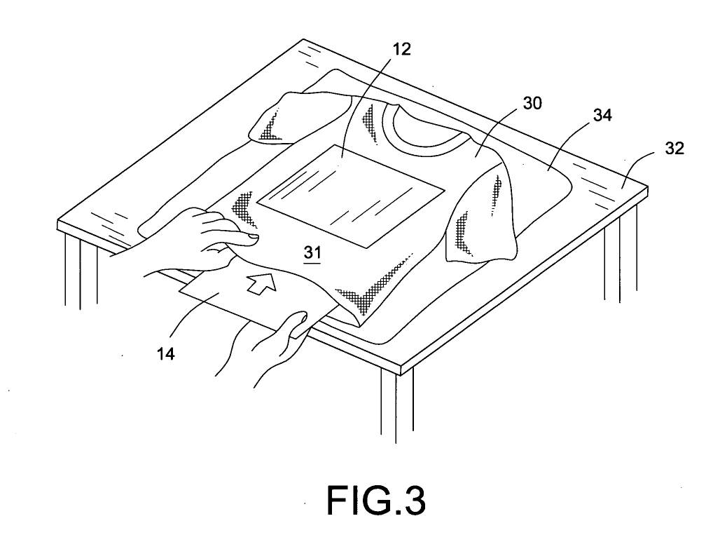

Turning now to FIG. 3, a T-shirt 30 is placed flat on a table top 32 which in this example has an insulating layer 34 overlying it. The transfer substrate 12 now carrying the personalized image 24 is laid with its transfer side 17 face down onto the front 31 (or indeed the back) of the T-shirt 30 preferably in the centre thereof. The protective cover 14 is conveniently placed within the body of the T-shirt 30 as shown in the figure as a further backing support.

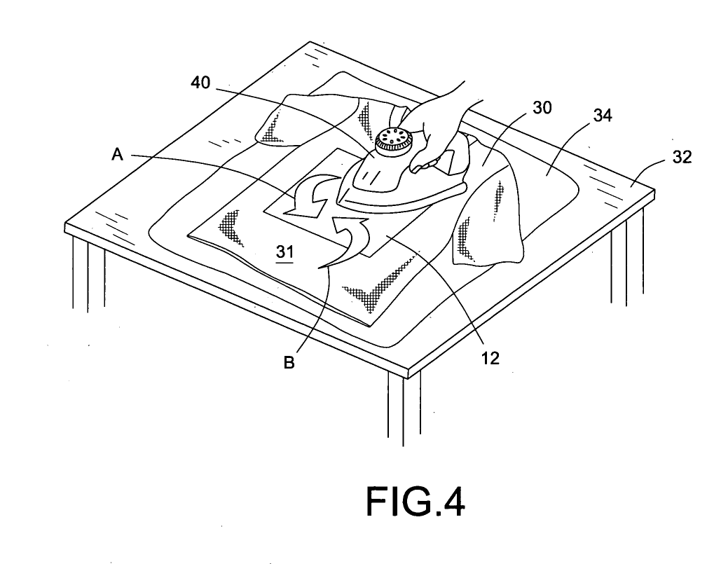

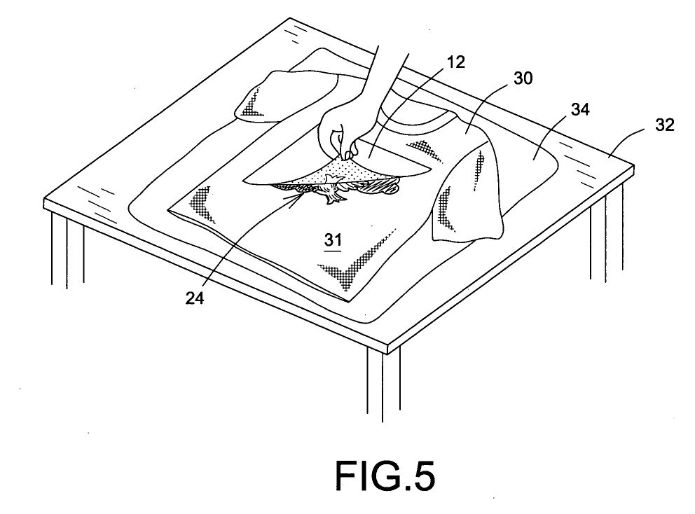

FIG. 4 illustrates the means of effecting the transfer of the image 24 to the front 31 of the T-shirt 30, namely the employment of a heated electric iron 40 which is moved under pressure over the whole of the back of the transfer substrate 12 as indicated by the arrows A, B. In this dual process of pressure and heat, the image 24 is duly transferred to the front of the T-shirt, as can be seen in FIG. 5 once the substrate is peeled from the front 31.

It will be understood that if the surface to which the image is to be transferred is carried by a rigid article, whether in sheet or other form, the step of inserting the protective cover becomes redundant.

Although the present invention of transfer printing system has been described with a certain degree of particularity, it is to be understood that the disclosure has been made by way of example only and that the present invention is not limited to the features of the embodiment described and illustrated herein, but includes all variations and modifications within the scope and spirit of the invention as hereinafter claimed.

I claim:

1. A transfer printing system comprising a transfer substrate in sheet form provided with a transfer side, a preformed design area carried on the said transfer side of the substrate and adapted to receive decorative materials, the preformed design area being provided with a release agent, and a non-adherent zone on the transfer side of the substrate extending around the design area.

2. A transfer printing system according to claim 1 wherein the substrate is in the form of a sheet.

3. A transfer printing system according to claim 1 wherein a protective cover is provided for the transfer substrate.

4. A transfer printing system according to claim 1 wherein the release agent is in the form a coating applied to the preformed design area.

5. A transfer printing system according to claim 4 wherein the release agent is viscous.

6. A transfer printing system according to claim 4 wherein the release agent is transparent or translucent.

7. A transfer printing system according to claim 4 wherein the release agent is selected from the following group, namely a waxy, adhesive, clear epoxy, resin, rubbery plastisol, oil-, acrylic- or water-based substance.

8. A kit for transfer printing comprising in combination transfer printing system according to claim 1, and at least one type of decorative material for application to the preformed design area on the transfer side of the transfer substrate.

9. A kit according to claim 8 and including more than one transfer substrate and more than one type of decorative material.

10. A kit according to claim 8 wherein the decorative materials are selected from the following, namely colouring media, textured media, particulate metals, decorative dusts, beads, small crystals, fluorescent or phosphorescent materials or materials possessing odorous qualities, or thermally responsive materials.

11. A method of transferring an image using transfer printing system according to claim 1 comprising the steps of removing the protective cover from the transfer substrate to reveal the transfer side and accordingly the preformed design area, applying at least one decorative material within the said design area to generate a personalized image, placing the transfer substrate onto a surface intended to carry said image, causing the image to transfer permanently to the surface by employing a suitable process in accordance with the nature of the decorative materials applied.

12. A method of transferring an image according to claim 11 wherein the process to effect permanent transfer of the generated image is selected from the following, namely pressure, heat or light or any combination thereof.

13. A method of transferring an image according to claim 11 wherein the surface to which the image is to be applied is carried by a flexible or a rigid sheet or other formation.
